(19) United States
(12) Patent Application Publication
(10) Pub. No.: US 2015/0359184 A1
(43) Pub. Date: Dec. 17, 2015

(54) AIRSHIPS FOR WEATHER MANIPULATION

(71) Applicant: LTA CORPORATION, New York, N (US)

(72) Inventor: John Goelet, Washington, DC (US)

(73) Assignee: LTA CORPORATION

(21) Appl. No.: 14/736,325

(22) Filed: Jun. 11, 2015

Related U.S. Application Data
(60) Provisional application No. 62/011,731, filed on Jun. 13, 2014.

(51) Int. Cl. A01G 15/00; B64B 1/14; B64B 1/06

(52) U.S. Cl. CPC A01G 15/00; B64B 1/06; B64B 1/14

(57) ABSTRACT

Airships for weather manipulation are disclosed. An airship may include a hull and a frame supporting the hull. The airship may also include a container configured to capture and transport a cloud. The airship may also include a sunlight reflecting system configured to block the sunlight over a destination area on ground. The airship may also include a nozzle configured to distribute a material to the cloud. The airship may also include a sensing system including at least one sensor configured to measure a parameter reflecting a condition of the cloud. The airship may further include at least one weather interference device configured to generate a wave or light and direct the wave or light toward the cloud. In some examples, two or more airships may be used to tow a parachute-style container deployable for capturing and transporting the cloud.

### PRIORITY CLAIM

This disclosure claims priority under 35 U.S.C. §119 to U.S. Provisional Patent Application No. 62/011,731 filed on Jun. 13, 2014, and entitled “Airships for Weather Manipulation.” The aforementioned application is incorporated herein by reference in its entirety.

### TECHNICAL FIELD

The present disclosure relates generally to airships and, more particularly, to airships for weather manipulation.

### BACKGROUND

Global warming has caused drastic changes to global weather and many areas have experienced abnormal weather patterns. For example, some traditionally dry regions have received extraordinary large volumes of rainfall, causing unexpected flooding. On the other hand, some traditionally precipitation-rich regions have experienced historical drought, devastating agriculture that depends heavily on the weather. At least due in part to the global warming caused by the increasing industrial activities, global weather has become more and more unpredictable and out of control.

A number of technologies have been developed to affect or manipulate weather. One of such technologies is known as cloud seeding, which has been implemented in dry regions to create or increase precipitation. To seed a cloud so that the cloud is ready for producing precipitation, cloud seeding materials, such as silver iodide (AgI), aluminum oxide, and barium, are injected into the cloud to facilitate small water droplets suspended within the cloud to form rains or snowflakes. The cloud seeding materials can be injected into the clouds in various ways. Traditionally, they may be injected into the clouds by airplanes, rockets, or cannons. Cloud seeding materials can also be raised into the air by the exhaust produced by a ground-based cloud seeding generator burning, for example, a gas (e.g., propane).

There are, however, disadvantages and shortcomings associated with the existing cloud seeding technologies. To be effective, cloud seeding requires the right time and the right candidate cloud. In other words, in order to turn a cloud into the rain, the cloud to be seeded must have the right conditions, such as the right amount or size of water droplets, temperature, humidity, etc. Not every cloud floating in the sky is a good candidate for precipitation-making. In particular, spreading rain-making materials at the wrong clouds would not turn the clouds into rain or snowfall. Thus, identifying the right candidate cloud is an important first step for effective cloud seeding. Existing technologies for cloud seeding, however, cannot identify the candidate cloud accurately, partly because of the lack of information about the conditions of the clouds. After the candidate cloud is identified, cloud seeding materials may be spread or distributed to the cloud using airplanes, rockets, cannons, or ground-based generators. These traditional distribution avenues, however, lack precision in targeting the candidate cloud. As a result, cloud seeding materials may be wasted and the efficiency and accuracy of cloud seeding may be limited.

Other technologies have been developed to manipulate weather in order to interfere, disrupt, or prevent the formation of storms, such as hurricanes, tornados, or hail. For example, people have attempted to spread, using airplanes, certain materials, such as, for example, silver iodide or a polymer powder, into clouds to reduce or change the conditions surrounding the water droplets suspended within the clouds, thereby reducing the possibility of forming a harmful storm. People have also developed other ideas to reduce the formation of hazardous weather. For example, hail cannons have been used to generate waves at certain frequencies towards the clouds to prevent formation of hail. These technologies, however, share common drawbacks with the existing cloud seeding technologies, e.g., the lack of precision in targeting the right clouds.

The present disclosure is directed toward improvements in existing technologies for manipulating weather.

### SUMMARY

In one exemplary embodiment, the present disclosure may be directed to an airship for weather manipulation. The airship may include a hull and a frame supporting the hull. The airship may also include a container positioned outside of the hull and mounted to the frame. The container may include a plurality of walls forming an enclosure, and an opening into the enclosure. The container may be configured to capture a cloud through the opening and transport the cloud in the enclosure.

In another exemplary embodiment, the present disclosure may be directed to a system for weather manipulation. The system may include at least two airships, each airship including a hull and a frame. The system may also include a container connected to the frames of the at least two airships such that the container is towed by the at least two airships. The container may be configured to capture and transport a cloud while the at least two airships are in flight.

In yet another exemplary embodiment, the present disclosure may be directed to an airship for weather manipulation. The airship may include a hull and a frame supporting the hull. The airship may also include a sunlight reflecting system mounted to the frame and configured to block sunlight over a selected area of the ground below the airship. The sunlight reflecting system may include a reflector including a substantially flat surface, and a mounting device supporting the reflector above the hull.

In yet another exemplary embodiment, the present disclosure is directed to an airship for weather manipulation. The airship may include a sensing system attached to the hull and including at least one sensor configured to measure a parameter reflecting a condition of the cloud. The airship may also include a weather manipulation device attached to the hull and configured to change the condition of the cloud. The airship may further include a memory for storing instructions, and a processor for executing the instructions to analyze the parameter measured by the at least one sensor, and control the weather manipulation device to change the condition of the cloud based on the analysis.

It is to be understood that both the foregoing general description and the following detailed description are exemplary and explanatory only, and not restrictive of the disclosed embodiments, as claimed.

### BRIEF DESCRIPTION OF THE DRAWINGS

The accompany drawings, which are incorporated in and constitute a part of this specification, illustrate disclosed embodiments and together with the description, serve to explain the disclosed embodiments. In the drawings:

FIG. 1 illustrates an exemplary airship for weather manipulation consistent with the disclosed embodiments;

FIG. 2 illustrates another exemplary airship for weather manipulation consistent with the disclosed embodiments;

FIG. 3 illustrates an exemplary container mountable to the airship for weather manipulation consistent with the disclosed embodiments;

FIG. 4 illustrates another exemplary container mountable to the airship for weather manipulation consistent with the disclosed embodiments;

FIG. 5 illustrates an exemplary airship for weather manipulation consistent with the disclosed embodiments;

FIG. 6 illustrates exemplary airships for weather manipulation consistent with the disclosed embodiments;

FIG. 7 illustrates exemplary airships for weather manipulation consistent with the disclosed embodiments;

FIG. 8 illustrates exemplary airships for weather manipulation consistent with the disclosed embodiments;

FIG. 9 illustrates an exemplary parachute-style container for weather manipulation consistent with the disclosed embodiments;

FIG. 10 illustrates another exemplary airship for weather manipulation consistent with the disclosed embodiments;

FIG. 11 illustrates an exemplary mounting device and parachute-style container for weather manipulation consistent with the disclosed embodiments;

FIG. 12 illustrates another exemplary mounting device and parachute-style container for weather manipulation consistent with the disclosed embodiments;

FIG. 13 illustrates an exemplary airship for weather manipulation consistent with the disclosed embodiments; and

FIG. 14 illustrates another exemplary airship for weather manipulation consistent with the disclosed embodiments.

### DETAILED DESCRIPTION

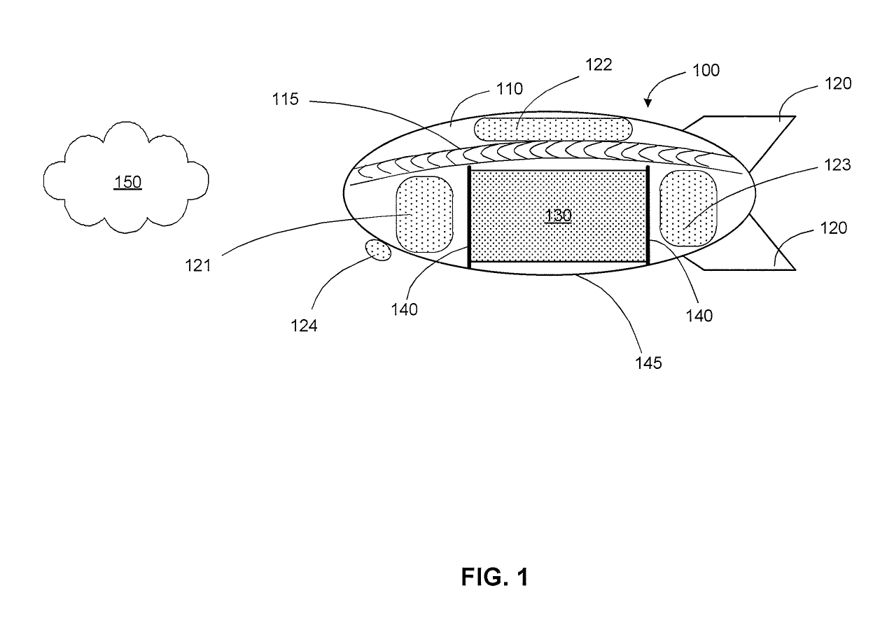

FIG. 1 illustrates an exemplary airship for weather manipulation consistent with the disclosed embodiments. In this exemplary application, an airship 100 may be used for moving clouds from one region to another, thereby achieving the goal of manipulating or at least affecting the weather at both regions. For example, it may be desirable to move clouds from a region where rainfall is excessive to a dry region where rainfall is scarce. Relocating clouds may affect the distribution of precipitation, such that flooding in a precipitation-rich region can be reduced, and drought in a dry region can be improved. As another example, it may be desirable to move clouds to a region where clouds are needed for reducing the amount of sunshine. For instance, at a parade or sport event taking place in a hot summer, it may be desirable to have more clouds in the sky over the region where the event takes place such that people are protected from excessive heat.

As shown in FIG. 1, airship 100 may be used to move a cloud 150. Airship 100 may be any suitable type of airship, including those airships disclosed in U.S. Patent Application Publication No. 2012/0018571 (“the '571 publication”). In some embodiments, structures and components of airship 100 may be similar to those discussed in the '571 publication. Detailed descriptions of the structures and components of an airship, as provided in the '571 publication, are incorporated herein by reference.

As shown in FIG. 1, airship 100 may include a hull 110. Hull 110 may be configured to contain a gas, such as a lighter-than-air gas (e.g., hydrogen or helium). Hull 110 may be any suitable shape, such as an oblong or lenticular shape. Airship 100 may include a frame or support structure 115 that supports hull 110. It is understood that only an exemplary portion of the frame 115 is shown in FIG. 1 for illustrative purposes. Frame 115 may be constructed from light-weight, but high-strength, materials, including, for example, a carbon-based material (e.g., carbon fiber), and/or aluminum. Hull 110 may also include an envelope (not shown) formed outside of the frame 115. The envelope may be fabricated from any suitable materials, including, for example, aluminized plastic, polyurethane, polyester, laminated latex, mylar, and/or any other material suitable for retaining the lighter-than-air gas. Airship 100 may include one or more stabilizing fins 120. Airship 100 may include a plurality of air chambers or bladders 121, 122, and 123 for containing the lighter-than-air gas. Airship 100 may also include a gondola 124 attached to the lower portion of hull 110. Although not shown in FIG. 1, airship 100 may include other features disclosed in the '571 publication, such as, for example, one or more propulsion devices, solar panels provided on the surface of hull 110, a chassis, an empennage assembly, landing gear, etc.

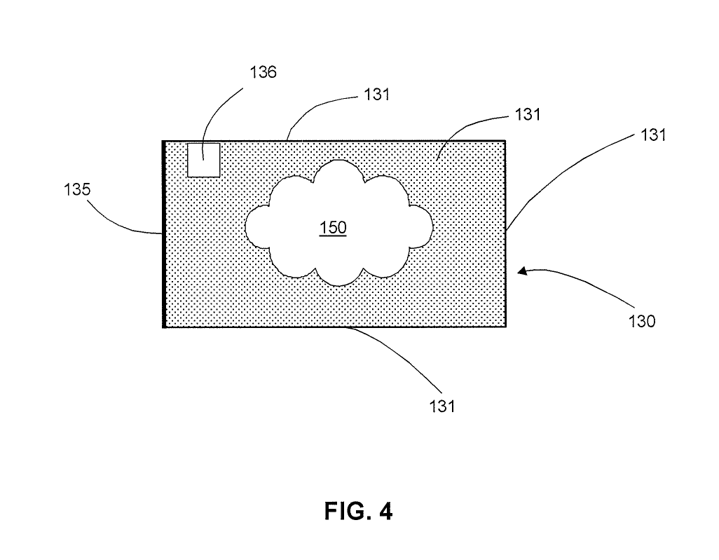

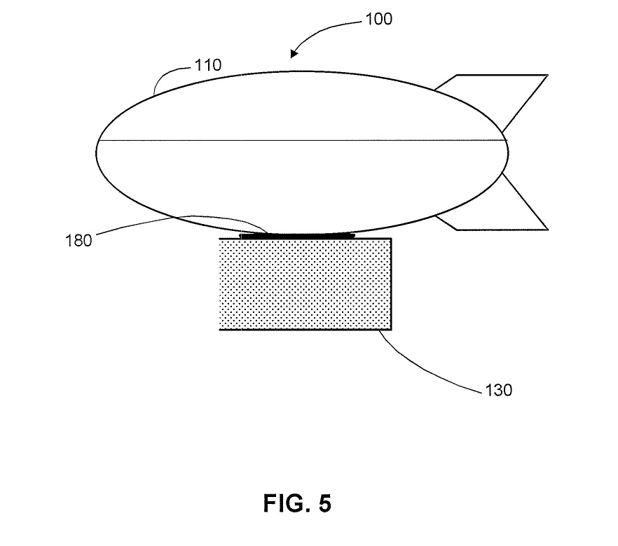

For the application of manipulating weather, and specifically, for moving clouds, airship 100 shown in FIG. 1 may include a container 130 for capturing and transporting a cloud. Airship 100 may also include one or more supporting rails 140. Container 130 may be any suitable shape, such as a rectangular cuboid shape, a cylindrical shape, etc. In the embodiment shown in FIG. 1, container 130 includes a rectangular cuboid shape (e.g., like a cargo container) having at least five walls (as discussed in FIGS. 4 and 5, the sixth wall may be optional). In this way, container 130 may include an enclosure and an opening into the enclosure. In use, container 130 may be positioned such that the opening faces an area horizontally spaced from container 130 (e.g., such that airship 100 may move horizontally to capture cloud 150). It should be understood, however, that other configurations are possible (e.g., the opening may face upwardly or downwardly).

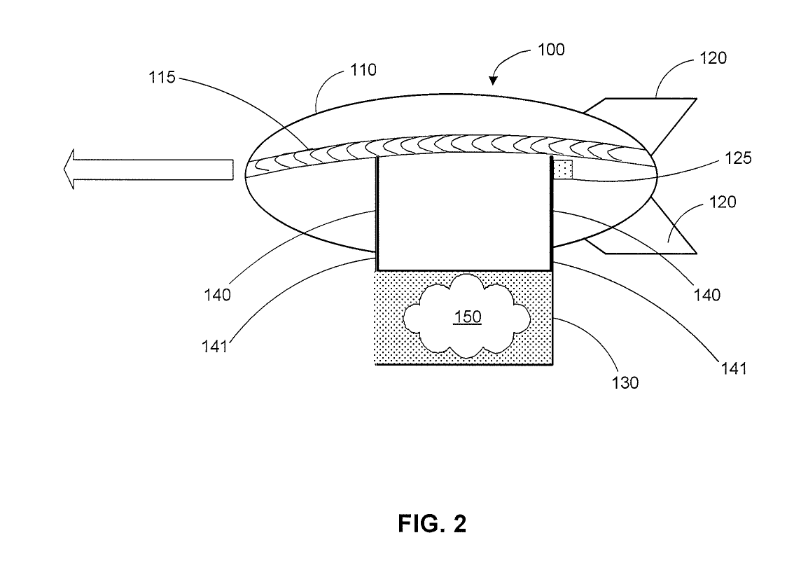

Container 130 may be constructed from at least one light-weight material, such as carbon fiber, aluminum, a fabric, a metal/alloy film, a plastic, a foam, etc. Container 130 may be mounted to frame 115 through supporting rails 140. For example, container 130 may be movably mounted on supporting rails 140, which may be mounted on frame 115. Container 130 may be moved along supporting rails 140 by a driving device 125 (shown in FIG. 2), such as a motor. As shown in FIG. 1, in one embodiment, the upper ends of supporting rails 140 are mounted on frame 115. It is understood that any other mounting methods may be used for mounting supporting rails 140 to frame 115. It is also understood that any other suitable structures and devices (other than supporting rails 140) may be used for raising and lowering container 130.

Container 130 may be retractable into hull 110 when not deployed and extendable out of hull 110 when deployed. In one embodiment, container 130 may be lowered and raised along supporting rails 140 by driving device 125 (shown in FIG. 2), such that when container 130 is not deployed for transporting clouds, container 130 may be retracted (e.g., raised) to be disposed within hull 110 (as shown in FIG. 1). When container 130 is to be deployed for transporting clouds, container 130 may be extended (e.g., lowered) to be disposed outside of hull 110 (as shown in FIG. 2). As shown in FIG. 2, portions 141 of supporting rails 140 may also be extended outside of hull 110 when container 130 is deployed. In addition, as shown in FIG. 1, a lower portion 145 of hull 110 (or the envelope) may be opened to allow container 130 to be extended out of hull 110. In one embodiment, lower portion 145 of hull 110 may include a motor-driven door constructed of a light-weight metal or light-weight plastic material. The motor-driven door may be opened to allow container 130 to exit hull 110, and may be closed when container 130 is retracted into hull 110.

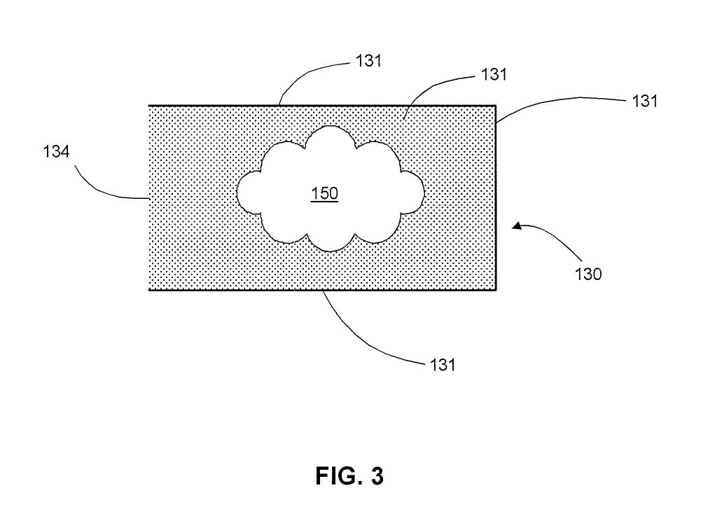

FIG. 3 illustrates an example of container 130 mountable to airship 110 for weather manipulation consistent with the disclosed embodiments. As shown in FIG. 3, container 130 includes a rectangular cuboid shape (e.g., a container) including five walls 131 (only four walls shown). It is understood that any other suitable shape (e.g., cylindrical) may be used for container 130. In this embodiment, the front end 134 of container 130 remains open (e.g., there is no wall covering the front end). FIG. 4 illustrates another example of container 130 mountable to airship 110 for weather manipulation consistent with the disclosed embodiments. As shown in FIG. 4, the front end of container 130 may also include a wall 135. Wall 135 may be opened and closed like a door. Wall 135 may be opened when container 130 is deployed to capture cloud 150 or when cloud 150 is to be released from container 130. While cloud 150 is transported by container 130 from a region to another, wall 135 may be closed.

In the embodiment shown in FIG. 4, container 130 may include a climate control system 136 configured to adjust the air condition within container 130. Climate control system 136 may include various devices for controlling the air condition within container 130, such as the temperature and humidity within container 130. For example, climate control system 136 may include at least one of a temperature sensor (not shown) or a humidity sensor (not shown) to measure at least one of the temperature or humidity of the air within container 130. Climate control system 136 may also include various devices (not shown), such as an air conditioner, a humidifier, a dehumidifier, etc., for adjusting the air condition within container 130 based on parameters (e.g., temperature and humidity) measured by at least one of the temperature sensor, the humidity sensor, etc. Climate control system 136 may adjust the condition of the air within container 130 while cloud 150 is being transported from one region to another, such that cloud 150 remains a condensed water vapor, rather than being evaporated or condensed into water. Climate control system 136 may include other sensors, such as a sensor that measures water droplet concentration within cloud 150.

As shown in FIGS. 1 and 2, airship 100 may be driven to a region where cloud 150 is located. Lower portion 145 may be opened, and driving device 125 may lower container 130 along supporting rails 140 until container 130 is out of hull 110. Airship 100 may be driven to approach cloud 150. With the front end of container 130 open (e.g., with the open front end 134 shown in FIG. 3, or with wall 135 shown in FIG. 4 opened), airship 100 may be maneuvered such that container 130 may capture (e.g., scoop up) cloud 150. When the embodiment shown in FIG. 4 is used for container 130, after container 130 captures cloud 150, wall 135 may be closed and remain closed during transporting cloud 150. Airship 100 may transport cloud 150 to a destination region using container 130. During the transportation, container 130 having cloud 150 may be retracted back into hull 110, e.g., to its original position before it was deployed. Alternatively, container 130 may remain extended out of hull 110 during the transportation. When the embodiment shown in FIG. 4 is used for container 130, climate control system 136 may adjust the air condition within container 130 such that cloud 150 remains a condensed water vapor. After cloud 150 is transported to the destination region within container 130, airship 100 may be maneuvered such that cloud 150 is released from container 130. When the embodiment shown in FIG. 4 is used for container 130, wall 135 may be opened to allow releasing of cloud 150. Although not shown, in some embodiments, all of the walls of container 130 may be openable to facilitate releasing of cloud 150. In addition, although not shown, a fan may be provided within container 130 to facilitate the release of cloud 150. After cloud 150 is released, all of the walls of container 130 may be closed. Airship 100 may travel back and forth between regions to move as many clouds as needed.

FIG. 5 illustrates an exemplary airship for weather manipulation consistent with the disclosed embodiments. Unlike the embodiment shown in FIG. 1, in this embodiment, container 130 is not retractable into and outside of hull 110. In this embodiment, container 130 is directly mounted to a keel portion 180 located at the lower portion of hull 110. Keel portion 180 may be a portion of frame 115. Keel portion 180 may be constructed of a suitable material, such as, for example, aluminum. Although not shown, it is understood that container 130 shown in FIG. 5 may include any feature discussed above for container 130.

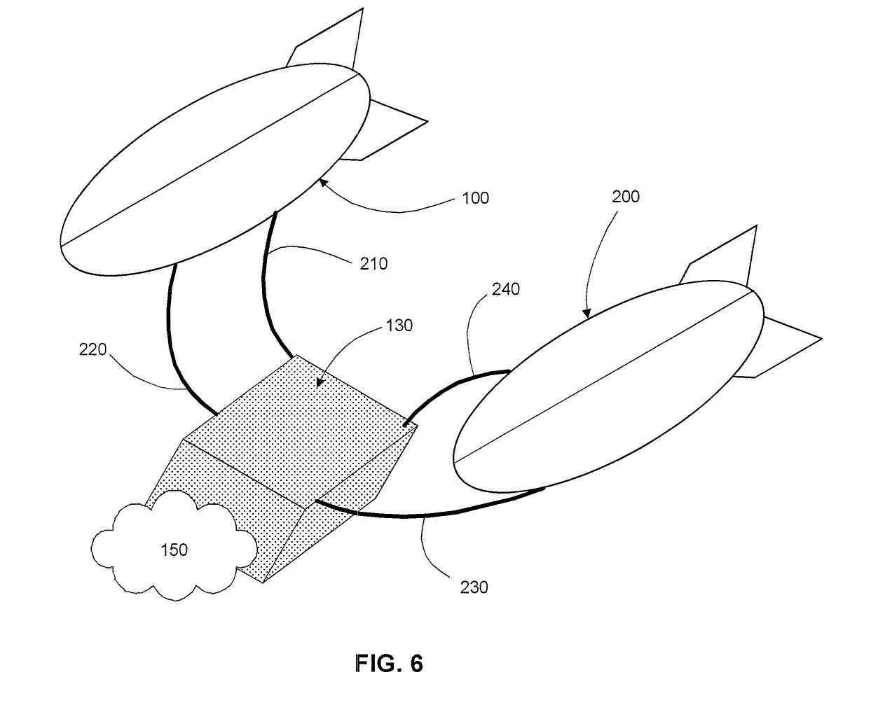

FIG. 6 illustrates exemplary airships for weather manipulation consistent with the disclosed embodiments. In this embodiment, more than one airship is used for moving clouds. Although FIG. 6 shows two airships towing container 130, it is understood that more than two airships may be used to tow container 130 for moving clouds. Compared to the examples shown in FIGS. 1-5 where a single airship is used, a larger container 130 may be towed using two or more airship. As shown in FIG. 6, a first airship 100 and a second airship 200 may together tow container 130. First airship 100 and second airship 200 may be similar, and may include features discussed above with respect to the airships shown in FIGS. 1-5. Each of first airship 100 and second airship 200 may include at least one towing cable or structure connecting first airship with container 130. For example, first airship 100 may include a first towing cable or structure 210 and a second towing cable or structure 220 connecting different parts of first airship 100 with container 130. Similarly, second airship 200 may include a third towing cable or structure 230 and a fourth towing cable or structure 240 connecting different parts of second airship 200 with container 130. The towing cables or structures 210, 220, 230, and 240 may be any flexible, light-weight cable or structure known to those skilled in the art.

Although not shown, it is understood that container 130 shown in FIG. 6 may include features discussed above with respect to the container shown in FIGS. 1-5. To move cloud 150, airships 100 and 200, with container 130 being towed in between, may be flown to the approach cloud 150. Airship 100 and 200 may be maneuvered such that container 130 captures (e.g., scoops up) cloud 150. With cloud 150 being contained within container 130, airships 100 and 200 may be flown to the destination region, and may release cloud 150 from container 130 at the destination region.

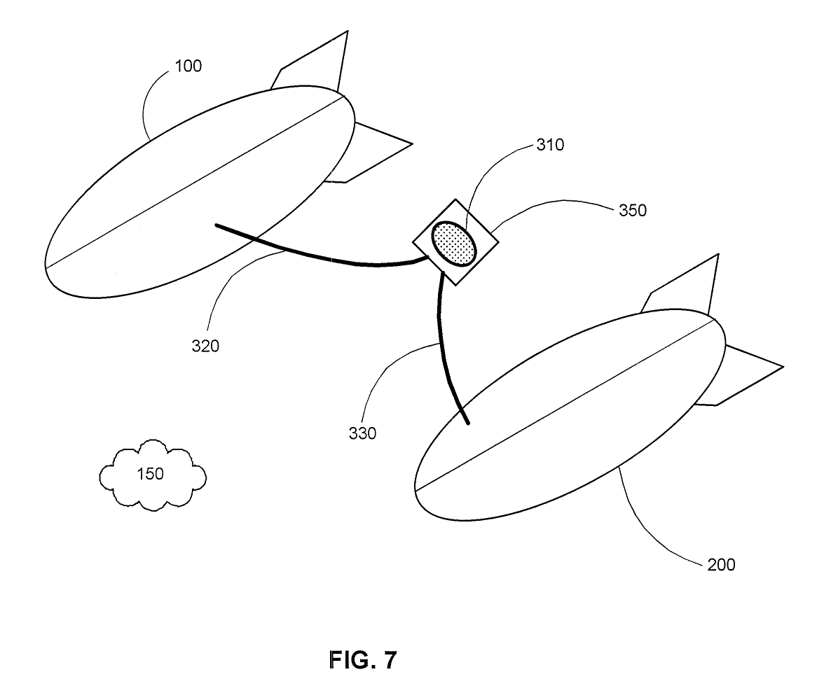

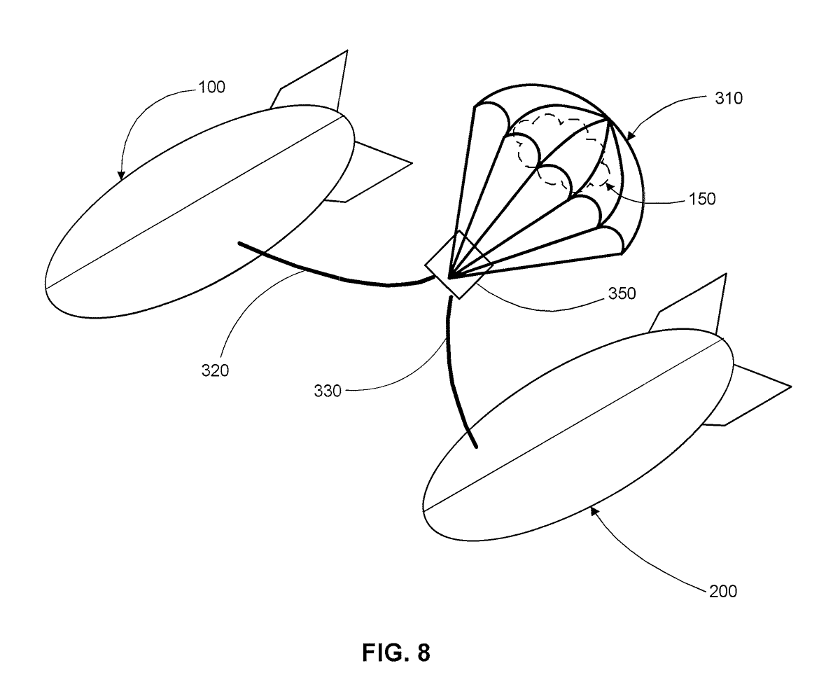

FIGS. 7 and 8 illustrate exemplary airships for weather manipulation consistent with the disclosed embodiments. In the embodiments shown in FIGS. 7 and 8, instead of towing container 130, airships 100 and 200 may tow a parachute-style container 310 (as shown in FIG. 8). FIG. 7 illustrates airships 100 and 200 towing parachute-style container 310 before the parachute of the parachute-style container 310 is deployed for moving cloud 150. FIG. 8 illustrates airships 100 and 200 towing parachute-style container 310 after the parachute of the parachute-style container 310 is deployed for moving cloud 150. Before the parachute of the parachute-style container 310 is deployed, as shown in FIG. 7, parachute-style container 310 may be folded and contained within a package 350. Because parachute-style container 310 may be folded into a compact size, package 350 may be small. Thus, the aerodynamics and stability of airships 100 and 200 may not be substantially affected when the package 350 is towed. As shown in FIG. 7, airships 100 and 200 may tow package 350 using towing cables or structures 320 and 330. Towing cables or structures 320 and 330 may be similar to towing cables or structures 210, 220, 230, and 240. Towing cables or structures 320 and 330 may connect package 350 with airships 100 and 200.

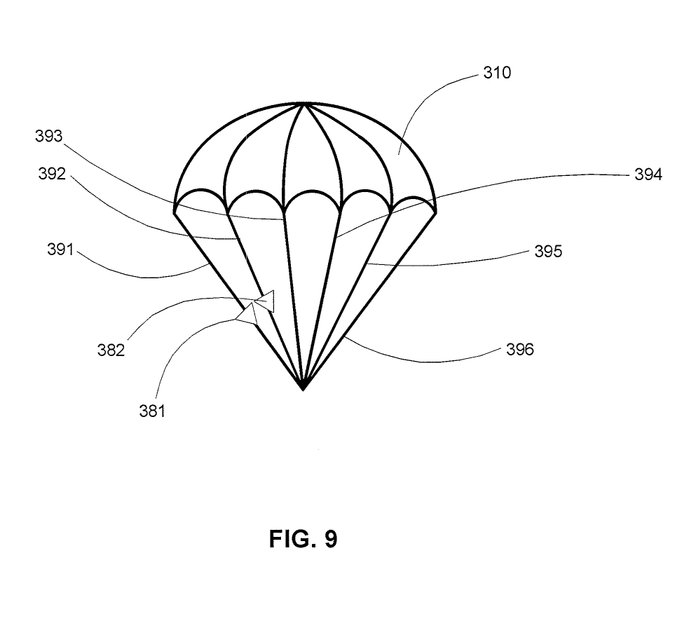

Parachute-style container 310 may resemble a parachute, as shown in FIGS. 8 and 9. Parachute-style container 310 may be configured for capturing and transporting a cloud, as shown in FIG. 8. Parachute-style container 310 may be made of a suitable material that is light-weight, strong, and flexible, such as fabric, nylon, silk, etc. To move cloud 150, airships 100 and 200 may be flown to approach cloud 150, with parachute-style container 310 disposed within package 350, as shown in FIG. 7. When airships 100 and 200 are near cloud 150, parachute-style container 310 may be deployed, as shown in FIG. 8. For example, parachute-style container 310 may be deployed using an electronic controller (not shown) disposed within package 350 that may be operated by the operator of airship 100 or 200. Airships 100 and 200 may be maneuvered such that cloud 150 is captured by parachute-style container 310 and located substantially within the canopy of parachute-style container 310. With cloud 150 being trapped within parachute-style container 310, airship 100 and 200 may tow cloud 150 from one region to another. During transportation of cloud 150 using parachute-style container 310, one or more propulsion devices (not shown) of airship 100 may be used to maintain the stability of airship 100 and 200. At the destination, cloud 150 may be released from parachute-style container 310. In some embodiments, cloud 150 may be released by disconnecting the suspension lines on one side of parachute-style container 310 such that parachute-style container 310 loses its expanded shape, thereby creating an exit for cloud 150 to escape or be released.

FIG. 9 illustrates an exemplary parachute-style container 310 that includes mechanisms for allowing disconnection of one or more suspension lines 391, 392, 393, 394, 395, and 396. For example, parachute-style container 310 may include a plurality of electronically-controlled connectors 381 and 382 distributed on some or all of suspension lines, e.g., suspension lines 391 and 392. The electronically-controlled connectors 381 and 382 may include mechanisms allowing for disconnection and reconnection. Such mechanisms may include, for example, pairs of electromagnets, which may be engaged when an electric current is supplied to the electromagnets, and disengaged from each other when the electric current is not supplied. When the electromagnets in the electrically-controlled connector 381 (or 382) are engaged, suspension line 391 (or 392) is connected. When the electromagnets in the electrically-controlled connector 381 (or 382) are disengaged, suspension line 391 (or 392) is disconnected. Operators of airships 100 and 200 may control the electrically-controlled connectors 381 and 382 using controllers (not shown) provided on airships 100 and 200. After cloud 150 is released at the destination, package 350 may retract parachute-style container 310, and may prepare parachute-style container 310 for the next cloud transportation task. In one embodiment, package 350 may include a device (not shown) for folding parachute-style container 310, and a device (not shown) for reconnecting suspension lines 391 and 392 by re-engaging the disconnected connectors 381 and 382.

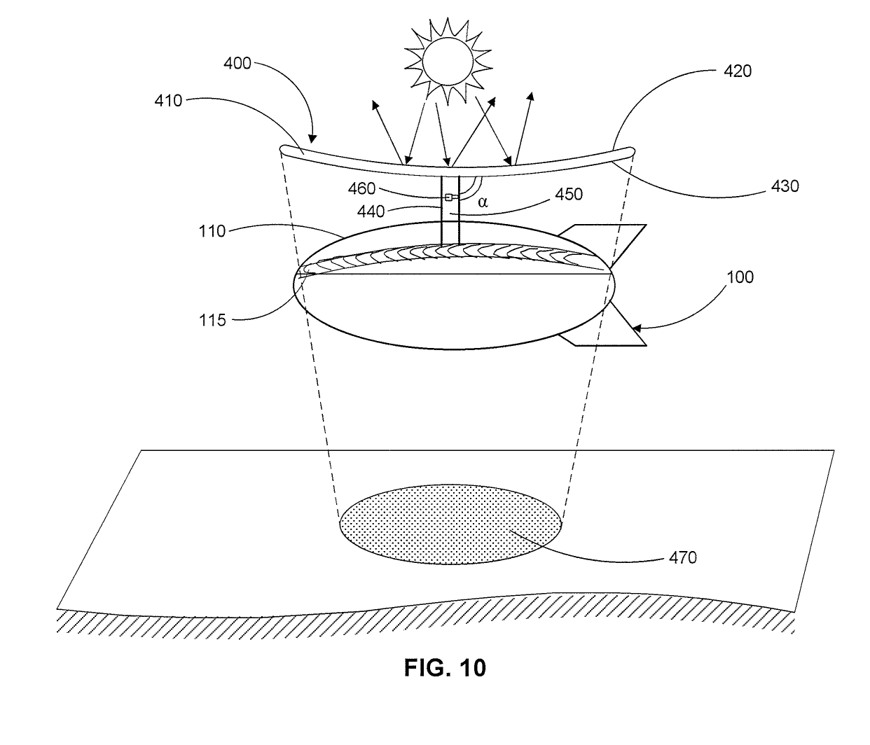

FIG. 10 illustrates an exemplary airship for weather manipulation consistent with the disclosed embodiments. FIG. 10 shows an application of airship 100 for reflecting sunlight, so as to reduce the amount of sunshine at a desired region on the ground. For example, during a sports event held in on a hot summer day, it may be desirable to temporarily reduce the amount of sunshine at the place where the sports event takes place. As shown in FIG. 10, airship 100 may include a sunlight reflecting system 400 to block or reflect away the sunlight. Sunlight reflecting system 400 may include a reflector 410 and a mounting device 440, both being mounted on airship 100. Reflector 410 may be mounted on airship 100 through mounting device 440, which may be mounted to frame 115. Reflector 410 may block the sunlight when it is deployed. Reflector 410 may include a first surface 420 and a second surface 430. Additionally, reflector 410 may reflect the sunlight. For example, first surface 420 may include a sunlight reflecting material. In one embodiment, first surface 420 may be coated with a thin metal film, such as an aluminum film, for reflecting the sunlight. Using a sunlight reflecting material to reflect sunlight may increase the efficiency of reducing the amount of sunlight incident on hull 110 of airship 100, and the amount of sunlight ultimately falling on the ground below airship 100. Reducing the amount of sunlight incident on hull 110 may prevent airship 100 from being overheated.

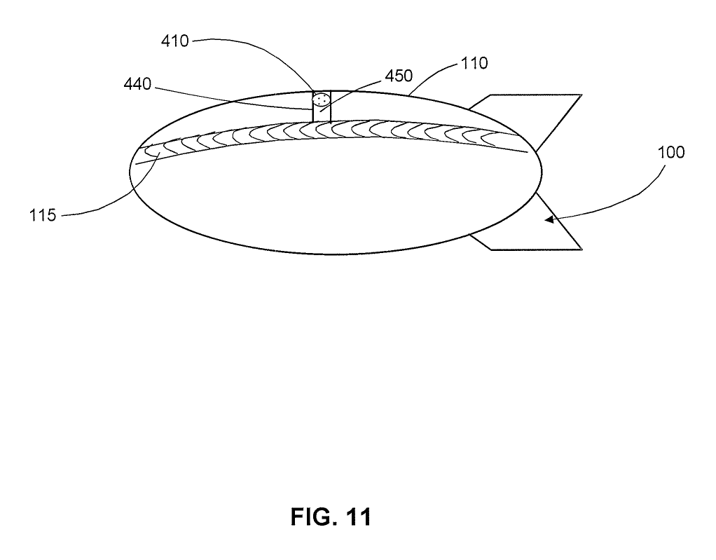

In some embodiments, reflector 410 may be inflatable and light-weight. For example, reflector 410 may be made of a material suitable for inflation and deflation, such as fabric or synthetic rubber. When not deployed, reflector 410 may be deflated and vacuumed to reduce its size. Deflated reflector 410 may also be folded to further reduce its size to be compact. In some embodiments, deflated reflector 410 may be stored within a chamber 450 located within mounting device 440, as shown in FIG. 11. Mounting device 440, with deflated reflector 410 stored therein, may be retracted into airship 110 so that mounting device 440 and reflector 410 are disposed within hull 110, as shown in FIG. 11. Although not shown, it is understood that mounting device 440 may not be retractable, but may remain extended outside of hull 110 (as shown in FIG. 10), even when deflected reflector 410 is deflated. It is further contemplated that deflated reflector 410 may not be stored within mounting device 440, but may be secured at the top end of mounting device 440.

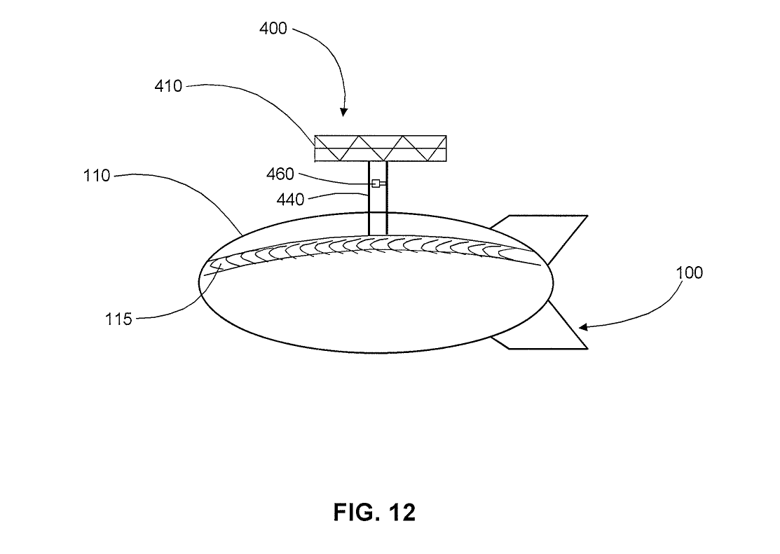

In some embodiments, reflector 410 may not be inflatable, but may include a foldable, relatively rigid structure. For example, reflector 410 may include a relatively rigid structure formed of a plurality of metal or composite material rods or beams. The rigid structure may be part of second surface 430, forming a supporting structure for first surface 420. First surface 420 may be formed of thin metal films (e.g., aluminum films) for reflecting the sunlight. When not deployed, the reflector 410 may be folded into a compact size and stored within airship 110 or disposed at the top end of mounting device 440. For example, second surface 430 that includes the plurality of rods or beams may be folded. As second surface 430 is folded, first surface 420 may also be folded. The entire reflector 410 may be folded into a compact size. FIG. 12 shows an embodiment in which folded reflector 410 is disposed at the top end of mounting device 440 and outside of hull 110. Because the size of the folded reflector 410 is relatively small, the aerodynamics and stability of airship 100 may not be significantly affected by the folded reflector 410 disposed outside of hull 110.

Mounting device 440 may be made of a light-weight and high-strength material, such as plastic, aluminum, carbon fiber, or other suitable metals. In the embodiment shown in FIGS. 10-12, mounting device 440 may be mounted on frame 115, and may be extended outside of hull 110. Mounting device 440 may have a suitable shape, such as a cylindrical shape. Mounting device 440 may include chamber 450 for storing various devices, such as the deflated reflector 410. Chamber 450 may also be used for housing a motor 460, as shown in FIG. 10. Alternatively, in some embodiments (not shown), motor 460 may be mounted on an outside surface of mounting device 440. Motor 460 may be part of sunlight reflecting system 400, and may be any suitable type, such as an electric motor. Motor 460 may be used for adjusting a tilt angle α of reflector 410. The tilt angle α may be defined by a vertical axis of mounting device 400 and second surface 430. Motor 460 may be electrically controlled by operators of airship 100, such that reflector 410 may be tilted to align first surface 420 (i.e., the sunlight reflecting surface) to face the sun for optimal reflection. Although one motor 460 and one tilt angle α is shown in FIG. 10 for illustrative purposes, it is understood that more than one motor 460 may be used for adjusting more than one tilt angle in more than one direction.

Airship 100 may be flown over a destination area 470 on the ground. Reflector 410 may be deployed using a suitable device (not shown) and the tilt angle α may be adjusted using the motor 460 to direct reflector 410 toward the sun. Sunlight may be reflected away or blocked by the first surface 420, thereby creating a shade or reducing the direct sunshine in area 470 on the ground. With reduced sunshine, the temperature and luminance at the area 470 may be reduced.

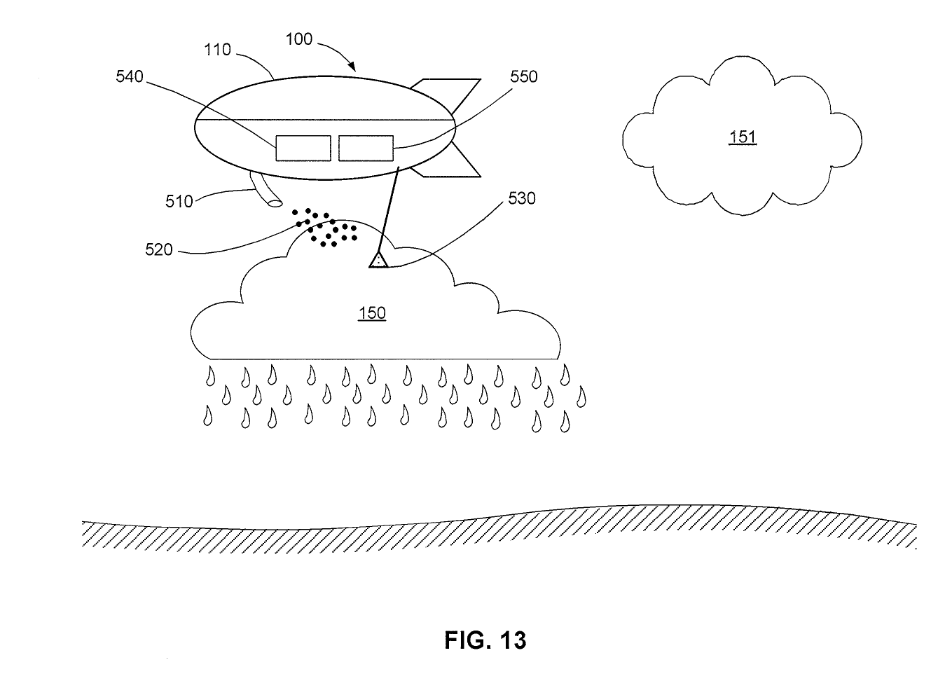

FIG. 13 illustrates an exemplary airship for weather manipulation consistent with the disclosed embodiments. Airship 100 may be used for cloud seeding. Airship 100 shown in FIG. 13 may include features discussed above. As discussed above, existing technologies for cloud seeding suffer from various shortcomings, including the lack of precision in distributing cloud seeding materials and the lack of information about the conditions of the clouds. Airship 100 overcomes these shortcomings. Airship 100 may include a weather manipulation device, such as a nozzle 510 mounted on airship 100 (e.g., attached to hull 110) for spreading cloud seeding materials, such as silver iodide (AgI), aluminum oxide, and barium, to a cloud. Airship 100 may include a sensing system 530 configured to measure parameters that reflect the conditions of a cloud (e.g., cloud 150 or 151). Sensing system 530 may be attached to hull 110. Sensing system 530 may include various sensors, such as at least one of a temperature sensor, a humidity sensor, or a water droplet size or amount sensor, etc., that measures various parameters associated with cloud 150 or 151.

Airship 100 may further include an onboard computer that may include at least one of a processor 540 or a memory 550, as shown in FIG. 13. Processor 540 may be any suitable processor, and may include hardware components, such as circuits, or software components, such as software codes, or a combination of hardware and software components. Memory 550 may be tangible, non-transitory, volatile, or non-volatile. Memory 550 may be any suitable memory, such as, for example, a flash memory, a Random Access Memory (RAM), a Dynamic Random Access Memory (DRAM), or a Read-Only Memory (ROM). Memory 550 may be configured for storing computer instructions, such as software codes. Memory 550 may also be configured for storing data, such as parameters measured by sensing system 530. Processor 540 may be configured to process the instructions stored in memory 550 to perform various functions (e.g., analysis of data). Processor 540 may also be configured to retrieve (e.g., read) data from memory 540 and process the retrieved data (e.g., by applying various software codes to analyze the retrieved data). Although not shown, it is understood that airship 100 may further include communication devices (e.g., antenna) configured to communicate date with a ground-based control center. For example, instead of or in addition to having processor 540 process the measured parameters, the communication devices of airship 100 may transmit the measured parameters to the ground-based control center for processing. Airship 100 may receive processing results from the ground-based control center, which may be used by processor 540 in controlling the application of cloud seeding.

Although not shown in FIG. 13, it is understood that processor 540, memory 550, nozzle 510, and sensing system 530 may be electrically connected with each other through at least one of wired connections or wireless connections. Parameters measured by sensing system 530 may be transmitted to memory 550 and stored therein. Processor 540 may retrieve measured parameters from memory 550 for processing. Alternatively, parameters measured by sensing system 530 may be directly transmitted to processor 540 and being processed by processor 540. Processor 540 may analyze the measured parameters to determine the conditions of clouds 150 and 151. If processor 540 determines that the conditions of a cloud (e.g., cloud 150) satisfy predetermined criteria for cloud seeding (e.g., the temperature, humidity, and water droplet size or amount satisfy their respective threshold values), i.e., if cloud 150 is the right candidate for cloud seeding, processor 540 may control nozzle 510 to distribute or spread cloud seeding materials to cloud 150. If processor 540 determines that the conditions of a cloud (e.g., cloud 151) do not satisfy the predetermined criteria for cloud seeding (e.g., the temperature, humidity, and water droplet size do not satisfy their respective threshold values), i.e., if cloud 151 is not the right candidate for cloud seeding, processor 540 may not activate nozzle 510 to distribute or spread cloud seeding materials to cloud 151.

For cloud seeding applications, airship 100 may be flown to the sky where clouds 150 and 151 are located. Airship 100 may be suspended in the sky above, near, or within the clouds 150 and 151. Airship 100 may periodically or continuously measure parameters reflecting the conditions of clouds 150 and 151 using the sensing system 530. Airship 100 may measure the parameters in real-time. When processor 540 determines, based on the analysis of the measured parameters, that cloud 150 is ready for cloud seeding, processor 540 may control nozzle 510 to spread cloud seeding materials to cloud 150. Because airship 100 may be suspended above, near, or within cloud 150, or may be flown above, near, or within cloud 150 at a low speed, cloud seeding materials may be distributed to cloud 150 in an accurate and efficient way. For example, it is understood that cloud 150 may be formed of a plurality of small cloud patches, which may or may not be evenly distributed within cloud 150. The conditions of the cloud patches may be different. Nozzle 510 may be controlled by processor 540 to selectively distribute cloud seeding materials to the cloud patches based on the analysis of the parameters associated with the cloud patches. For example, nozzle 510 may distribute the cloud seeding materials in a non-even pattern because the cloud patches are distributed non-evenly within cloud 150. Processor 540 may control nozzle 510 to distribute cloud seeding materials selectively to some cloud patches within cloud 150, but not to all cloud patches.

If one application of cloud seeding to cloud 150 does not result in an expected amount of precipitation, airship 100 may return to cloud 150 at a later time. The conditions of cloud 150 may be re-checked by measuring the parameters using sensing system 530. Processor 540 may re-analyze the newly measured parameters to determine whether a second cloud seeding may be applied to cloud 150. Likewise, if processor 540 determines that cloud 151 is not the right candidate for cloud seeding, airship 100 may return to cloud 151 at a later time. Conditions of cloud 151 may be re-checked by measuring the parameters using sensing system 530. Processor 540 may re-analyze the measured parameters to determine whether cloud 151 is ready for cloud seeding. With the airship 100 equipped with sensing system 530, nozzle 510, processor 540, and memory 550, accuracy and efficiency in cloud seeding may be significantly improved.

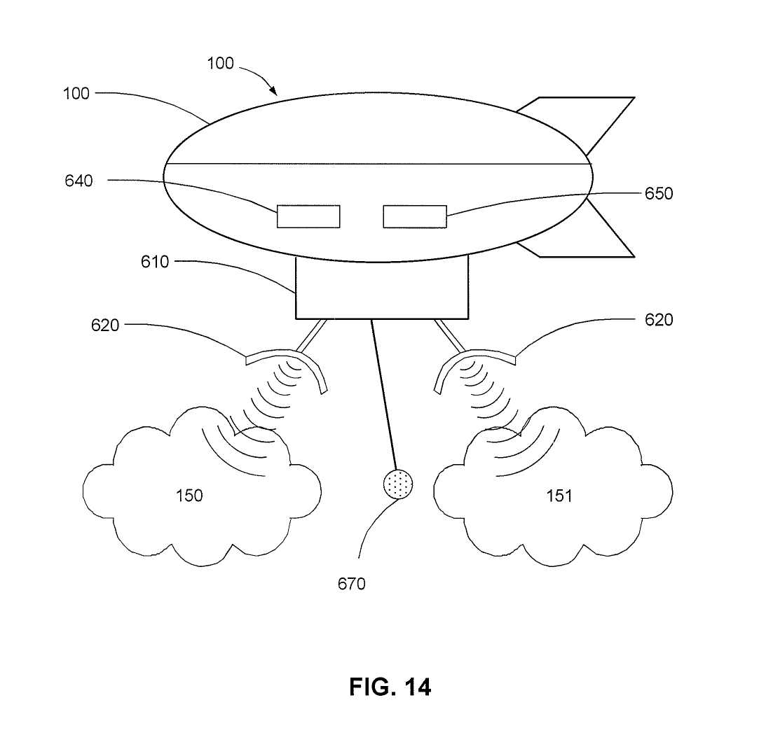

FIG. 14 illustrates an exemplary airship for weather manipulation consistent with the disclosed embodiments. Airship 100 may be used to interfere with the formation of hazardous weather, such as a storm (e.g., a rain or snow storm, a tropical storm, a hurricane, a tornado, and a hail storm). Airship 100 may include a gondola 610 located at a lower portion of airship 100. Airship 100 may include a weather manipulation device, such as a storm interference system including a plurality of storm interference devices 620, a sensing system 670, and an onboard computer having at least a processor 640 and a memory 650. The plurality of storm interference devices 620 may be mounted to gondola 610. It is contemplated that in some embodiments, the plurality of storm interference devices 620 may be directly mounted to airship 100 without using gondola 610. Storm interference devices 620 may be configured to generate waves or light at certain frequencies and direct the waves or light toward clouds for interfering with the formation of a storm. Storm interference devices 620 may include a wave generator (not shown separately) configured to generate a wave at a selected frequency or a frequency spectrum. For example, the wave generator may be configured to generate a microwave at one or more microwave frequencies within the range of 300 MHz to 300 GHz. The microwave may be directed toward a cloud. The microwave may apply heat to the water droplets, causing the water droplets to evaporate and reduce their sizes. Reducing the sizes of the water droplets may interfere, disrupt, or prevent the formation of at least some types of storms. In some embodiments, the wave generator may generate other types of waves, such as a shock wave (e.g., an abrupt, pulsed wave) to break the ice or hail formed within cloud 150, thereby reducing the severity or preventing the formation of the storms. In some embodiments, interference devices 620 may include laser devices (not shown separately) configured to emit a laser light. The laser light may be directed at a cloud to heat the cloud. Increasing the temperature of the cloud may interfere the aggregation of the water droplets suspended therein, thereby interfering, disrupting, or preventing the formation of storms. Because airship 100 may be flown at a low speed through the clouds, and may be suspended near, above, or within a cloud, the above discussed storm interference technologies may be accurately applied to the target clouds.

As shown in FIG. 14, airship 100 may further include an onboard computer having at least a processor 640 and a memory 650. Processor 640 and memory 650 may be similar to processor 540 and memory 550 discussed above with respect to FIG. 13. It is understood that processor 640 and memory 650 may also be different from processor 540 and memory 550 shown in FIG. 13. Airship 100 may include a sensing system 670. Sensing system 670 may be configured to measure various parameters associated with clouds, thereby enabling real-time monitoring of the conditions of the clouds. For example, sensing system 670 may be configured to periodically or continuously measure parameters indicating the conditions of the clouds. Similar to sensing system 530 shown in FIG. 13, sensing system 670 may include at least one of temperature sensors, humidity sensors, sensors for measuring the size and amount of water droplet. In addition, sensing system 670 may include other devices, such as radar, thermo imaging sensors, infrared sensors, etc., for measuring other parameters (e.g., movement of the clouds, thermo pattern of the clouds, etc.) indicating the conditions of the clouds. Parameters measured by sensing system 670 may be transmitted to memory 650 and stored therein, or may be transmitted directly to processor 640 for processing. Processor 640 may analyze the parameters measured by sensing system 670 to determine the conditions of the clouds and the status of storm formation. Based on the analysis, processor 640 may selectively identify certain clouds for applying the storm interference technologies, such that storm interference may be achieved accurately and efficiently. For example, processor 640 may select cloud 150 but not cloud 151, and may control interference devices 620 to generate and apply waves or light toward only cloud 150. In addition, based on the analysis of the measured parameters, processor 640 may determine parameters indicating the energy (e.g., the frequency and amplitude) of the waves or light to be generated and applied to cloud 150. With the disclosed airship 100 having the storm interference system, storm interference technologies may be more accurately and efficiently applied to storm-forming clouds.

The disclosed airships may be used in a variety of applications for weather manipulation. For example, the disclosed airships may be used for climate control over a small area, such as a football stadium, by using one or more airships. The disclosed airships may be used for climate control over a large area by using a plurality of airships. The disclosed airships may also be used over all terrains, including the sky over deserts or high mountains, where transportation of existing precipitation-making devices, such as rockets, cannons, or ground-based cloud seeding generators, may be challenging.

Because airships may be flown at a low speed or may be suspended in the air, accurate knowledge about the conditions of the clouds may be acquired. As a result, accuracy and efficiency in weather manipulation (such as moving a cloud, cloud seeding, or storm interference discussed above) may be significantly improved. Moreover, because lighter-than-air airships can be operated without refueling for a relatively long time (e.g., several days, weeks, or even months), continuous weather manipulation may be achieved.

The foregoing description has been presented for purposes of illustration. It is not exhaustive and is not limited to the precise forms or examples disclosed. Modifications and adaptations will be apparent to those skilled in the art from consideration of the specification and practice of the disclosed examples. The examples shown in the figures are not mutually exclusive. Features included in one example shown in one figure may also be included in other examples shown in other figures.

It will be apparent to those skilled in the art that various modifications and variations can be made in the disclosed airships for weather manipulation. Other embodiments will be apparent to those skilled in the art from consideration of the specification and practice of the disclosed embodiments herein. It is intended that the specification and examples be considered as exemplary only, with a true scope of the disclosure being indicated by the following claims.

What is claimed is:

1. An airship for weather manipulation, comprising:
a hull;
a frame supporting the hull; and
a container positioned outside of the hull and mounted to the frame, the container comprising:
a plurality of walls forming an enclosure; and
an opening into the enclosure,
wherein the container is configured to capture a cloud through the opening and transport the cloud in the enclosure.

2. The airship of claim 1, wherein the container is mounted to a keel portion of the frame located at a lower portion of the hull.

3. The airship of claim 1, further comprising:
at least one supporting rail mounted to the frame, and
wherein the container is mounted to the at least one supporting rail, and is movable along the at least one supporting rail.

4. The airship of claim 3, wherein the container is retractable into the hull and extendable outside of the hull by movement along the at least one supporting rail.

5. The airship of claim 1, wherein the container includes a movable wall configured to open and close the opening.

6. The airship of claim 1, wherein the container includes a climate control system configured to adjust air conditions within the container.

7. A system for weather manipulation, comprising:
at least two airships, each airship including a hull and a frame; and
a container connected to the frames of the at least two airships such that the container is towed by the at least two airships,
wherein the container is configured to capture and transport a cloud while the at least two airships are in flight.

8. The system of claim 7, wherein the container comprises a plurality of walls forming an enclosure, and an opening into the enclosure, and
wherein the opening faces toward a horizontal direction when the container is towed by the at least two airships such that the container is open to an area horizontally spaced from the container.

9. The system of claim 7, wherein the container is a parachute-style container configured to be deployed to capture and transport the cloud.

10. The system of claim 9, further comprising a package for containing the parachute-style container, wherein the parachute-style container is folded and contained within the package when the parachute-style container is not deployed.

11. The system of claim 9, wherein the parachute-style container includes a plurality of suspension lines and at least one electronically-controlled connector disposed on at least one suspension line of the plurality of suspension lines, the at least one electronically-controlled connector configured to connect and disconnect the at least one suspension line.

12. An airship for weather manipulation, comprising:
a hull;
a frame supporting the hull; and
a sunlight reflecting system mounted to the frame and configured to block sunlight over a selected area of the ground below the airship, the sunlight reflecting system comprising:
a reflector including a substantially flat surface; and
a mounting device supporting the reflector above the hull.

13. The airship of claim 12, wherein the sunlight reflecting system further comprises a driving device configured to adjust a tilt angle of the reflector.

14. The airship of claim 12, wherein the reflector includes a first surface configured to reflect sunlight, and a second surface configured to support the first surface.

15. The airship of claim 12, wherein the reflector is retractable into the mounting device and extendable outside of the mounting device.

16. The airship of claim 14, wherein the reflector is inflatable.

17. The airship of claim 14, wherein the reflector is foldable.

18. An airship for weather manipulation, comprising:
a hull;
a sensing system attached to the hull and including at least one sensor configured to measure a parameter reflecting a condition of the cloud;
a weather manipulation device attached to the hull and configured to change the condition of the cloud;
a memory for storing instructions; and
a processor for executing the instructions to:
analyze the parameter measured by the at least one sensor; and
control the weather manipulation device to change the condition of the cloud based on the analysis.

19. The airship of claim 18, wherein the weather manipulation device is a nozzle configured to distribute a material to the cloud.

20. The airship of claim 18, wherein the weather manipulation device is a weather interference device configured to generate a wave or light and direct the wave or light toward the cloud.
